(19) United States
(12) Patent Application Publication
(10) Pub. No.: US 2018/0188931 A1
(43) Pub. Date: Jul. 5, 2018

(54) SYSTEM AND METHOD FOR PRESENTATION OF A CONTROL INTERFACE AND LAUNCHER

(71) Applicants: Jamdeo Canada Ltd., Oakville (CA); Hisense Electric Co., Ltd., Qingdao (CN); Hisense USA CORP., Suwanee, GA (US); Hisense International Co., Ltd., Qingdao (CN)

(72) Inventors: Sanjiv SIRPAL, Oakville (CA); Mohammed SELIM, Oakville (CA); Alexander DePaz, Burlington (CA); Salvador SOTO, Toronto (CA); Saulo Correia DOURADO, Oakville (CA); Robert MacArthur, Milton (CA); Dean BRITTO, Mississauga (CA)

(73) Assignees: Jamdeo Canada Ltd., Oakville (CA); Hisense Electric Co., Ltd., Qingdao (CN); Hisense USA CORP., Suwanee, GA (US); Hisense International Co., Ltd., Qingdao (CN)

(21) Appl. No.: 15/396,016

(22) Filed: Dec. 30, 2016

(51) Int. Cl. G06F 3/0484; G06F 3/0482

(52) U.S. Cl. CPC G06F 3/04847; G06F 3/0482

(57) ABSTRACT

The present disclosure relates to processes and systems for operation of a display device such as a digital television. In one embodiment, a method for display device operation includes detecting a command for presentation of a control interface, and presenting a control interface according to a spatial arrangement model. The control interface is presented to include a graphical presentation of a launcher component for selection and presentation of content, a graphical presentation of a dashboard component to present a personalized interface based on a user profile, and a graphical presentation of an activity strip to present a plurality of tile elements for selected content. The method includes detecting a command for navigation relative to the control interface, and updating presentation of the control interface to present an intermediate display format for the control interface. The launcher, dashboard and activity strip are accessible for selection during the intermediate display format.

### FIELD

The present disclosure relates to electronic devices and applications, and more particularly to display and content presentation devices.

### BACKGROUND

Recent television devices are designed and developed to provide application and network services in addition to traditional television functions for display of broadcasted content. With the addition of functionalities and components on television devices, there exists a need for control interfaces for applications and television components. In particular, there exists a need for programs and configurations that allow for features of the applications to be presented, accessed and customized on a digital television. Traditional televisions are now being used to view network based content though non-conventional distribution channels. As such, display devices are required to provide an interface for traditional broadcasts, from cable providers and internet based service providers.

It can be difficult for device manufactures to provide menu based configurations that fit all functions required of a display device. There exists a need for improved control of television features. Moreover, there exists a desire for interfaces to be customizable and to provide content and display elements relevant to a display device use pattern. Conventional interfaces often require complex menus that are slow to load and require navigation several menu levels. There is a desire for modified configurations to optimize control and experience of display devices and digital televisions.

### BRIEF SUMMARY OF THE EMBODIMENTS

Disclosed and claimed herein are methods, devices and systems for control of display devices. One embodiment is directed to a method for display device operation including presentation of a control interface, the method including detecting, by a display device, a first command for presentation of a control interface for the display device. The method also includes presenting, by the display device, a control interface according to a spatial arrangement model and including interface components, wherein the control interface is presented to include a graphical presentation of a launcher component, the launcher component configured for selection and presentation of content, a graphical presentation of a dashboard component, the dashboard component configured to present a personalized interface based on a user profile, and a graphical presentation of an activity strip, the activity strip configured to present a plurality of tile elements for selected content. The method also includes detecting, by the display device, a command for navigation relative to the control interface, and updating, by the display device, presentation of the control interface to present an intermediate display format for the control interface, wherein each of the launcher component, dashboard component and activity strip are accessible for selection during presentation of the intermediate display format.

In one embodiment, the first command is received by the display device from a remote control device.

In one embodiment, the spatial arrangement model defines the arrangement of each of the launcher component, dashboard component and activity strip relative to one another and provides a plurality of display presentation formats for each of the launcher component, dashboard component and activity strip to provide navigation within each component and control of the display device.

In one embodiment, the spatial arrangement model is characterized by a T shape layout which each of the launcher component, dashboard component and activity strip relative positioned at a terminus of the T shape.

In one embodiment, the launcher component includes a tab bar having a plurality of tab elements, a primary region and a secondary region, wherein the primary region and secondary region are presented to include a plurality of content tiles based on a selected tab of the tab bar.

In one embodiment, the personal dashboard component includes a control interface within at least one of a background, avatar, welcome message, widget and content strip based on a selected user profile.

In one embodiment, the activity strip includes a plurality of graphical display tiles, wherein each tile is arranged in a horizontal strip to provide selected content based on activity detected with the display device.

In one embodiment, the control interface presentation in response to first command includes presentation of a first format for the launcher component, a first format for the dashboard component and a first format for activity strip each, wherein a first format of components includes a display format of reduced size and functionality for each component.

In one embodiment, the intermediate display format presents the launcher component as a bottom bar of tab elements, the dashboard component as a graphical representation of a selected user dashboard, and the activity strip as a plurality of content tiles arranged in a horizontal strip with reduced size.

In one embodiment, each of the launcher component, the dashboard component and the activity strip are configured for navigation by directional commands within the component and for expanded and reduced presentation formats based on navigation within a component.

Another embodiment is directed to a digital television including a display configured to present a control interface and a processor coupled to the display. The processor is configured to detect a first command for presentation of a control interface for the display device. The processor is also configured to present a control interface according to a spatial arrangement model and including interface components, wherein the control interface is presented to include a graphical presentation of a launcher component, the launcher component configured for selection and presentation of content, a graphical presentation of a dashboard component, the dashboard component configured to present a personalized interface based on a user profile, and a graphical presentation of an activity strip, the activity strip configured to present a plurality of tile elements for selected content. The processor is also configured to detect a command for navigation relative to the control interface, and update presentation of the control interface to present an intermediate display format for the control interface, wherein each of the launcher component, dashboard component and activity strip are accessible for selection during presentation of the intermediate display format.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of a control interface of a display device according to one or more embodiments;

FIG. 2 depicts a simplified system diagram according to one or more embodiments;

FIG. 3 depicts a process for device operation including presentation of a control interface according to one or more other embodiments;

FIG. 4 depicts a process for presentation of a control interface according to other embodiments;

FIG. 5A depicts a graphical representation of control interface components and a spatial arrangement model according to one or more embodiments;

FIG. 5B-5F depicts graphical representations of control interface display formats according to one or more embodiments;

FIG. 6 depicts a graphical representation of control interface components and presentation according to one or more embodiments;

FIG. 7 depicts a graphical representation of a dashboard component according to one or more embodiments;

FIG. 8 depicts a graphical representation of a launcher component according to one or more embodiments;

FIG. 9 depicts a graphical representation of a launcher component according to one or more embodiments;

FIG. 10 depicts a graphical representation of a launcher component according to one or more embodiments;

FIGS. 11A-11B depict graphical representations of a launcher component according to one or more embodiments;

FIG. 12 depicts a graphical representation of a launcher component according to one or more embodiments; and

FIGS. 13A-13E depict graphical representations of a launcher component according to one or more embodiments.

### DETAILED DESCRIPTION OF THE EXEMPLARY EMBODIMENTS

### Overview and Terminology

One aspect of the disclosure relates to providing a control interface for a digital television. In one embodiment, a system and framework are provided for presentation of a control interface according to a spatial arrangement model and including interface components. Components of the control interface include a graphical presentation of a launcher component configured for selection and presentation of content, a graphical presentation of a dashboard component configured to present a personalized interface based on a user profile, and a graphical presentation of an activity strip configured to present a plurality of tile elements for selected content.

Another aspect is directed to presenting a multiple layered approach to presentation of a user interface having multiple display formats relative to a highlight or selection element of the control interface. By way of example, the control interface can allow for navigation and modification of a component while still allowing for minimal navigation inputs to select and navigate within the display format of another control interface component. Providing multiple levels for each format allows for a visual control interface that can be operated from a distance without touch commands, the use of a mobile application and allows for control with a remote device having a directional pad. Another aspect is directed to personalization of a control interface, and in particular control interface operation to access and utilize the personal dashboard. In one embodiment, features of the control interface may be modified or personalized. In additional the control interface may store and allow for operation of a plurality of user profiles/personal control interfaces.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

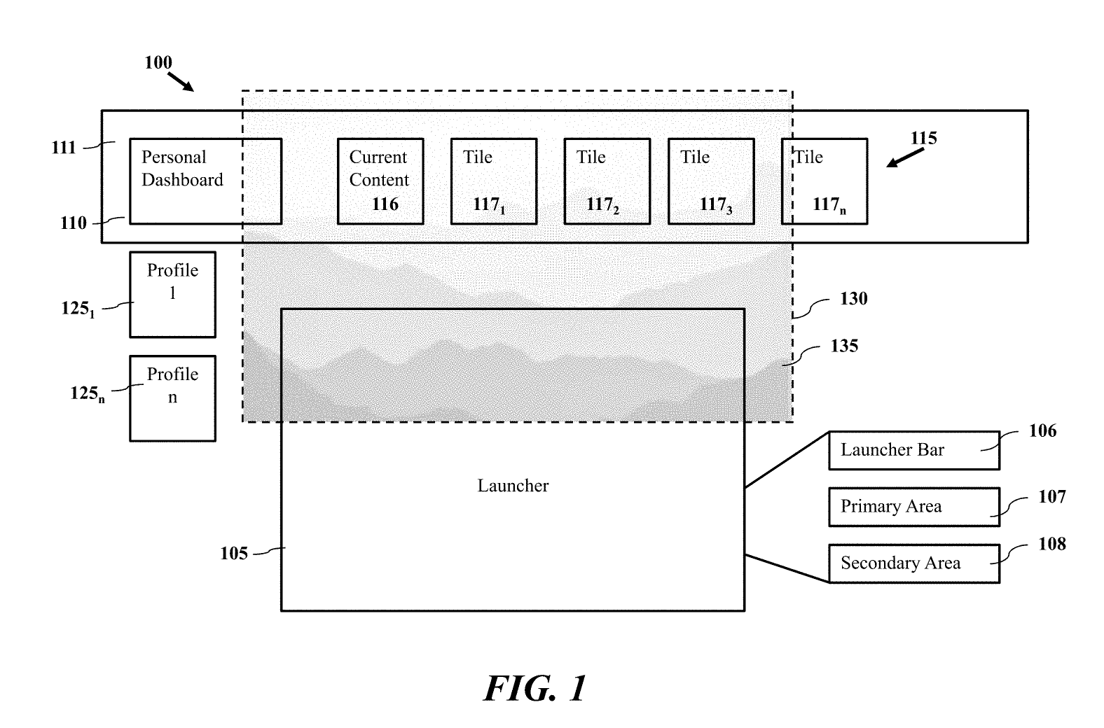

Referring now to the figures, FIG. 1 depicts a graphical representation of a control interface of a display device according to one or more embodiments. According to one embodiment, control interface 100 relates to a graphical user interface presented to control a display device, such as a digital television. According to one aspect of the disclosure, control interface 100 includes a plurality of components that each provide a plurality of functions and features for control and operation of a display device. In addition to providing separate components for particular interaction, control interface may also be configured to operate with a specific arrangement. According to one embodiment, presentation of each component of control interface 100 is presented based on a spatial arrangement model. According to one embodiment, the spatial arrangement model defines a relative position of components of control interface 100 to allow for directional navigation of the interface. By employing a spatial arrangement model, components of the control interface 100 allow for many features of the display device to be easily accessed and controlled. In addition to facilitating access, the spatial arrangement model provides a specific formatting to each view of control interface to emphasize elements for control.

According to one embodiment, components of control interface 100 include launcher component 105, dashboard component (e.g., personal dashboard) 110 and activity strip 115. According to another embodiment, a spatial arrangement model defines the location of each component of control interface 100 relative to a display screen. In an exemplary embodiment, launcher component 105 is oriented relative to a bottom portion of the display, dashboard component (e.g., personal dashboard) 110 is oriented relative to a left side of the display, and activity strip 115 is oriented relative a right side of the display. According to another embodiment, the display format of each component is defined by the spatial arrangement model such that each component may have an initial presentation characterized by a particular format, size, functionalities displayed, etc. Based on navigation commands relative to the control interface, the display device may update and rearrange the position and display format for each component of control interface 100.

Control interface 100 is shown in FIG. 1 relative to a display 130 and display content 135. According to one embodiment, the display format of control interface 100 can include presentation of some or all components of the control interface on display 130. Based on commands detected during presentation of the control interface 100, a display device may update the presentation format and elements of control interface 100 on display 130.

According to one embodiment, control interface 100 provides a mechanism for accessing multiple components of a display device. While the description of FIG. 1 discusses three components of control interface 100 (launcher component 105, dashboard component 110 and activity strip 115), it should be appreciated that additional components may be added to or included with control interface 100. As will be discussed herein, control interface 120 may be employed to control operation of digital television.

Activity bar includes plurality of tile elements 116 and 117₁₋ₙ. According to one embodiment, presentation of control interface 100 may be presented as an overlay to content 135 presented on display 130. The display device may freeze or continue presenting the display output of content 135 in a tile element 116 in activity bar 115. In certain embodiments, navigation away from current content tile 116 will pause or stop playback. Current content tile 116 allows for selection of the previously displayed content to return to presentation of the display. Current content tile 116 is presented based on the content displayed by the display device prior to display of control interface 100. Tile elements 117₁₋ₙ relate to activity feed based on current content. In one embodiment, tile elements 117₁₋ₙ, relate to a single type of content, such as broadcast TV shows related current content 116 and/or based on viewing habits of an active profile. According to another embodiment, tile elements 117₁₋ₙ may be a mix of content types, such as broadcast content, video on demand, applications, etc. In one embodiment, a display device may curate content and features to be included with activity bar as tile elements 117₁₋ₙ, and present activity bar as a horizontal deck of elements in horizontal region 111. Horizontal region 111 allows for left and right directional commands to navigate to and within components of control interface 110.

Profiles 125₁₋ₙ relate to one user profiles stored by a display device for control interface 100. In one embodiment, profiles 125₁₋ₙ are utilized to determining display format of the personal dashboard component 110. According to another embodiment, one or more elements of launcher component 105 and activity strip 115 may be presented base on an active profile of profiles 125₁₋ₙ. When a profile has not been selected, an active profile may be the last selected or utilized user profile.

According to another embodiment, components of control interface 100 may be selected, navigated and updated based on user interactions with a display device and one or more inputs from a remote control. According to one embodiment, elements of control interface 100 are presented by display device 130, such as digital television, as part of control interface 120.

Presentation of control interface 100 may be in response to a command from remote control, such as selection of a home or menu key. According to another embodiment, control interface 100 may be displayed shortly after a power on of display device 130. According to another embodiment control interface 100 may be presented following presentation of a wake animation and prior to display of a sleep or shutdown animation.

From control interface 100, several features and functions of a display device may be provided by ordered combinations of display device operation and graphical elements presented by the display device.

Launcher

According to one embodiment, launcher component 105 is configured to allow for a user to access content and control features of the display device. In one embodiment, launcher component includes a launcher bar 106, primary area 107 and secondary area 108. Launcher bar 106 may related to a plurality of tab elements arranged in a horizontal strip, wherein selection by moving a highlight element of the display device to a tab element will update the presentation elements of the launcher. By way of example, launcher bar 105 may include a tab for broadcast channels, video on demand and display device settings. Primary area 107 may include presentation of tile elements below the launcher bar 106. Tile elements of primary area 107 may be selected by the display device as the most relevant content of features associated with a selected tab element. Secondary area 108 may be presented below the primary area with additional tiles associated with content and/or display device function. Secondary area 108 may allow for additional selectable elements. According to one embodiment, the display format of launcher bar 106, primary area 107, and secondary area 108 may be based on the presentation status of the control interface. For example, launcher component may be presented initially with launcher bar 106, then commands to expand launcher component (e.g., a directional command) can result in display device updating the display output to include one or more tile elements of the primary area. Tile elements of the secondary area 108 may be presented based on additional navigation within the launcher component.

According to one embodiment, an initial format, such as a home screen presentation, of control interface 100 includes presentation of launcher bar, and a row of tile elements of the primary area. Based on a user input to select and/or navigate within launcher component 105, additional formats may be presented such as an increase in presentation footprint of the launcher to allow for secondary area 108 to include additional rows of tile elements. According to another embodiment, the primary area 107 and secondary area 108 of launcher component 105 may also include a first section for presentation of a most relevant tile element, and a second section for presentation of other tile elements along a horizontal display plane.

According to one embodiment, control interface 100 provides launcher component 105 as an overlay control interface to allow for presentation of content and control features based on selection of launcher tabs and navigation within the launcher component. In one embodiment, the configuration of launcher component 105 is a progression away from traditional desktop menus and allows for simple directional commands to access TV, network, applications, recommendations, personalized configurations, and recent content. According to another embodiment, launcher bar 106 of launcher component 105 includes a plurality of tab or tile elements, wherein each tab allows for a selection of a particular type of content, source of content, and/or control features of a display device. Based on the selection of a tab element of launch bar 106, launcher component may present multiple rows of content/element tiles and allows for scrolling to additional rows within a display window to provide and extended content region. In one embodiment, each row of content tiles may be navigated to based on vertical directional commands (e.g., up/down) and rows of content tiles may be navigated with horizontal directional commands (e.g., left/right). The presentation order of rows and even tiles in each row may be based on one or more of a selected user profile, content presented prior to display of control interface 100 and relevance determinations. In additional to content, such as video and programming information, tiles presented in launcher component 105 may relate to one or more of applications, settings, smart home applications, education/learning applications, gaming, etc.

Launcher Search

According to one embodiment, control interface 100 may include a search functionality component including a graphical interface for searching content titles, applications and elements of launcher component 105. In one embodiment, the search functionality may be presented as a drop down (e.g., down sliding transition) interface from an intermediary presentation format of control interface 100. According to another embodiment, the search functionality can interact with other devices (e.g., mobile devices) with a display device hosting a network interface for entry of search queries. Features of the search functionality can include one or more of a text entry box, alpha numeric display, recent search listing and suggested search results.

Personal Dashboard

According to one embodiment, control interface 100 includes dashboard component 110 to provide a user customizable control interface for a portion of the control features. In one embodiment, dashboard component 110 provides graphical elements for selecting and modifying display attributes and functionality of the dashboard. According to another embodiment, dashboard component can allow for a graphical selection of user profiles that can define features of control interface 100.

According to one embodiment, personal dashboard component 110 allows for presentation of a personalized control interface associated with a user profile. By way of example, display device is configured to allow a user to personalize the display format of the user interface to select display attributes such as a wallpaper, avatar, etc. In that fashion, dashboard component 110 allows for presentation of a personalized control interface. According to one embodiment, control interface 100 can allow for presentation of several user profiles 125₁₋ₙ. Selection of the profile may be performed during navigation to personal dashboard component 110 within control interface 100. According to one embodiment, the initial display presentation format of personal dashboard component 110 relates to a tile element, such as a screen capture of the personal dashboard. When an intermediate display configuration of control interface 100 is provided, the same tile representing personal dashboard component 110 may be reformatted. According to one embodiment, personal dashboard component 110 may be displayed adjacent to activity bar 115 in a horizontal region 111 of the display.

In one embodiment, dashboard component 110 provides a display interface to include notifications and access to applications which may be run by a display device. According to another embodiment, dashboard component 110 allows for personalization such as one or more of wake/sleep animations, screensavers, audio themes, badges and gaming. Dashboard component 110 allows for a customizable interface within the overall control interface 100 of a display device.

Touch Interface

Presentation of elements within control interface can include one or more display formats and format changes. In certain embodiments, presentation of elements introduces similarities of touch commands to a display device operated from a distance without actual contact to the display. According to one embodiment, control interface 100 can update presentation of display elements such as tiles to gradually reveal content. According to one embodiment, control interface 100 can receive inputs based on a capacitive touch sensor with gradual display of elements, but also allowing for accidental touches. Capacitive interaction can provide a control feature with a level of touch control for a display device that is normally operated/viewed from a distance. Control interface 100 may be configured with an interaction to model tactile representation for interaction with elements based on a capacitive/interactive remote control. In one embodiment, interaction may include progressive disclosure of content, a multilayered preview into content and instant access to recommendation.

Contextual Touch

According to one embodiment, elements of control interface 100 can support presentation of tile elements as overlay to content without presentation of the full control interface. By way of example, a display device may be configured to recognize a category or genre of actively displayed content and present a display of similar programs to avoid the need to access a display menu and searching of content.

Instant Companion Application and Search

According to one embodiment, control interface 100 can allow for control of a display device by a mobile device and to allow for presentation of graphical display elements of control interface 100 to be displayed by a mobile device. In one embodiment, control interface 100 may host temporary access between a display device and another web enabled device. According to another embodiment, devices may be paired based on displayed elements that may be detected by the web enabled device. Thus, control interface 100 may be configured for pairing/connection with a user interface, such as a personalized user dashboard for display devices and search functions within the launcher control interface. According to certain embodiments, interaction of a mobile device with control 100 does not require a user to download a specific application to establishing the temporary network connection for interaction and control of a display device.

Smart Sense Recommendations

According to one embodiment, control interface 100 can utilize one or more processes for populating content elements within launcher component 105. According to one embodiment, control interface 100 may be presented based on processes for tracking and identifying content for recommendation within the launcher component. For example, content tiles may be arranged in groupings such that groupings with the highest contextual relevance priority are arranged towards the top of launcher component 105.

Conversense

According to one embodiment, control interface 100 and elements of control interface 100 can be utilized by a display device to present a display configured tailored to startup of the display device with information and display elements having high relevance. In one embodiment, elements of the startup display may be selected and presented based on a recognized time of day, personal settings and history.

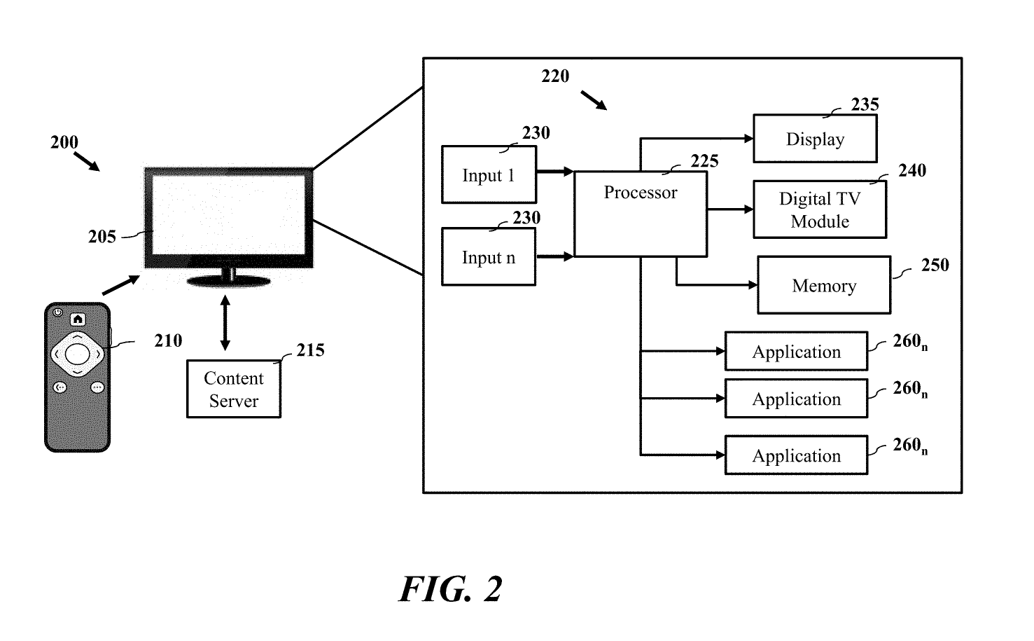

FIG. 2 depicts a simplified system diagram according to one or more embodiments. System 200 includes display device 205 and remote control 210. Remote control 210 may be configured to provide commands for interaction with and control of display device 205 relative to a control interface (e.g., control interface 100) presented by display device 205. Content, applications and other network services may be provided to display device 205 by way of one or more content servers, such as content server 215.

Digital television 200 includes processor 225, inputs 230, display 235, digital TV module 240, memory 250, and applications 260₁₋ₙ. It should be appreciated that digital television 205 may include one or more additional components not shown in FIG. 2. Digital television 205 is configured to present a control interface as described herein.

Inputs 230 relate to physical inputs for receiving video/image content and/or network data for presentation of content on display 235. Digital TV module 240 includes decoder/converter elements to receive information and content from inputs 230 which is then formatted and output to processor 225 for presentation on display 235. Memory 250 may include ROM and RAM memory for operation of digital television 205 and processor 225.

Processor 225, in addition to controlling operation of a digital television, is configured to control presentation and operation of a control interface. According to one embodiment, processor 225 is configured to detect commands for presentation of a control interface for the digital television, present the control interface including an expanded tab element and a plurality of tab elements. Processor 225 may also detect second or additional commands for the control interface to select one of the plurality of tab elements and update presentation of the control interface in response to the commands.

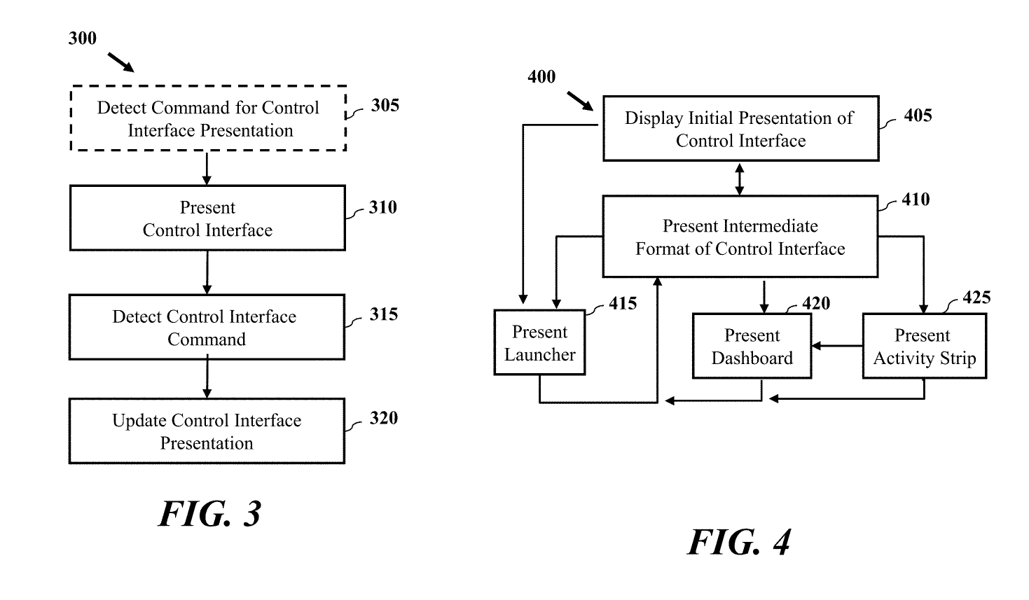

FIG. 3 depicts a process for device operation including presentation of a control interface according to one or more other embodiments. Process 300 may be employed by a device (e.g., display device 205) to provide a control interface, and in particular presentation and updating of the control interface in response to received commands. According to one embodiment, process 300 is performed by a processor (e.g., processor 225) based on instructions stored in non-transitory memory 250.

Process 300 may optionally include detecting a command for presentation of a control interface at block 305. In one embodiment a display device (e.g., display device 205) receives a command from a remote control (e.g., remote control 210). Detection of a first command for presentation of a control interface for the display device at block 305 may be based on selection of a menu or home key on the remote control. In certain embodiments, detection of a first command at block 305 is in response to a mobile device pairing the display device and/or launch of an application on the mobile device to operate the display device.

At block 310, the display device presents the control interface. Detection of a command is optional in process 300 as a display device may present a control interface during use without requiring detection of a control command. For example, the display device may present a control interface at block 310 during a wake up process of the display device. In other embodiments, the display device may present the control interface at block 310 following viewing of content, connection of an external device, inadvertent button presses on a remote, pairing of a mobile device, etc.

According to one embodiment, a control interface is presented at block 310 according to a spatial arrangement model and including interface components. As will be discussed in more detail below, a spatial arrangement model defines the arrangement of each of the launcher component, dashboard component and activity strip relative to one another in the control interface. According to another embodiment, the spatial arrangement model provides a plurality of display presentation formats for each of the launcher component, dashboard component and activity strip to provide navigation within each component and control of the display device. In one embodiment, the spatial arrangement model is characterized by a T shape layout which each of the launcher component, dashboard component and activity strip are positioned at a terminus of the T shape.

In block 305, the control interface is presented to include graphical presentations of a launcher component, dashboard component and activity strip. The launcher component is configured for selection and presentation of content. In one embodiment, the launcher component includes a tab bar having a plurality of tab elements, a primary region and a secondary region, wherein the primary region and secondary region are presented to include a plurality of content tiles based on a selected tab of the tab bar. The dashboard component presents a personalized interface based on one or more user profiles. In one embodiment, the personal dashboard component includes a control interface within at least one of a background, avatar, welcome message, widget and content strip based on a selected user profile. The activity strip is configured to present a plurality of tile elements for selected content. In one embodiment, the activity strip includes a plurality of graphical display tiles, wherein each tile is arranged in a horizontal strip to provide selected content based on activity detected with the display device.

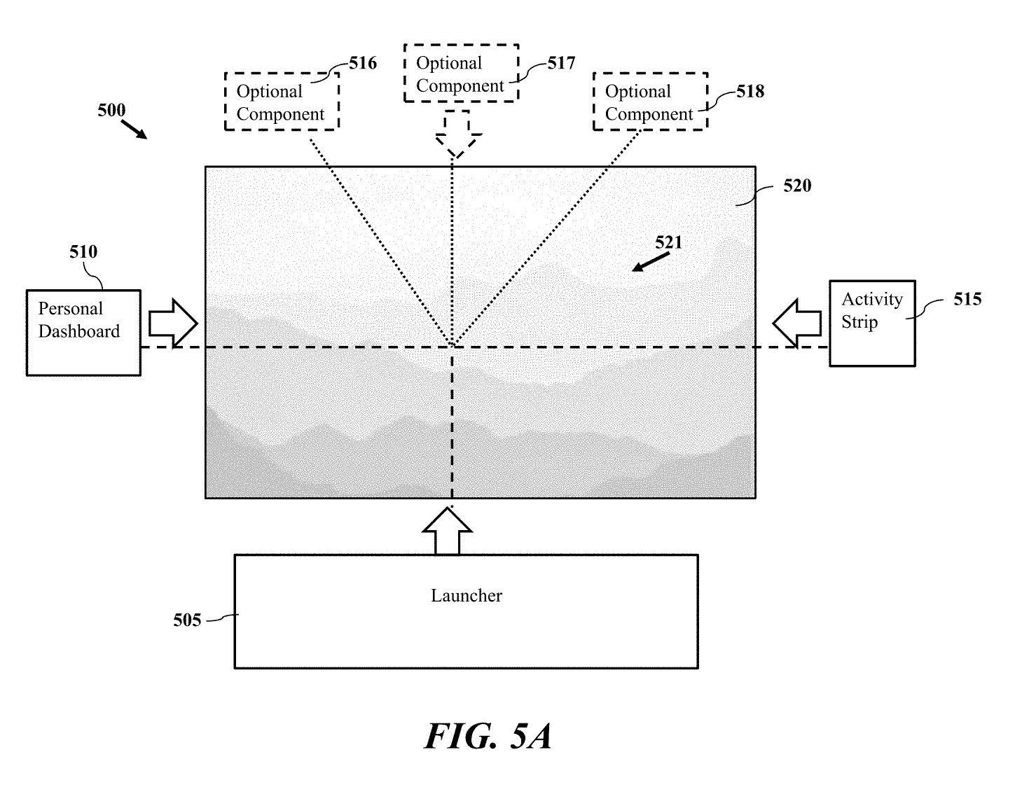

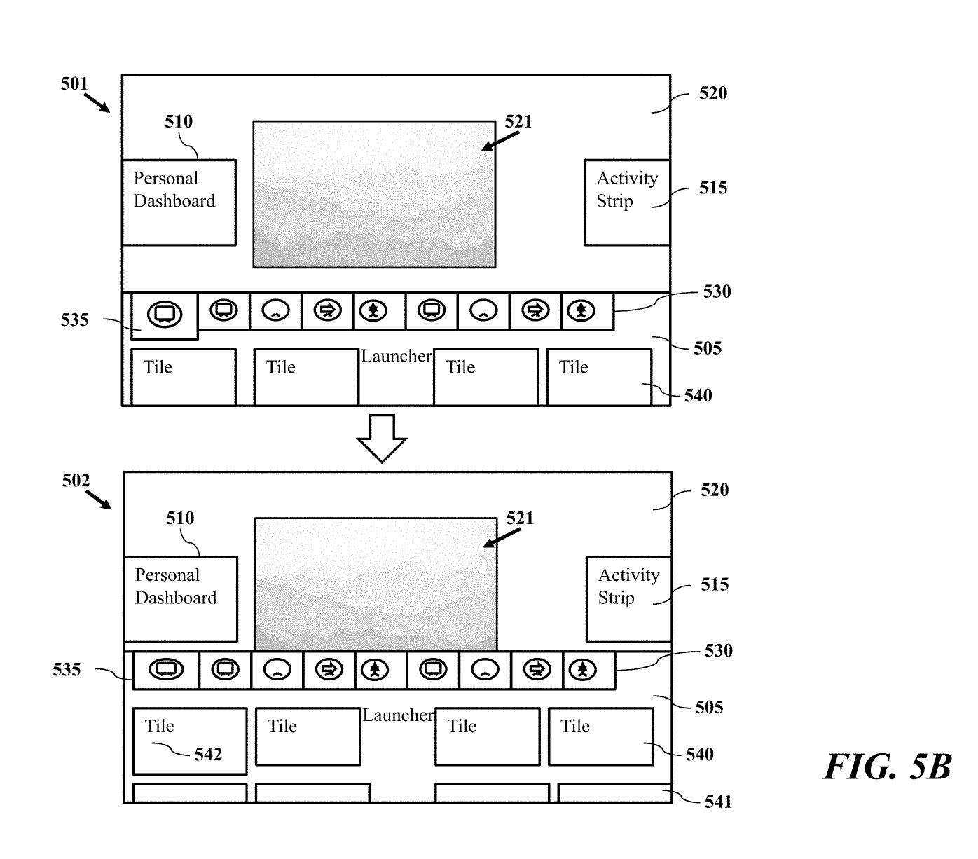

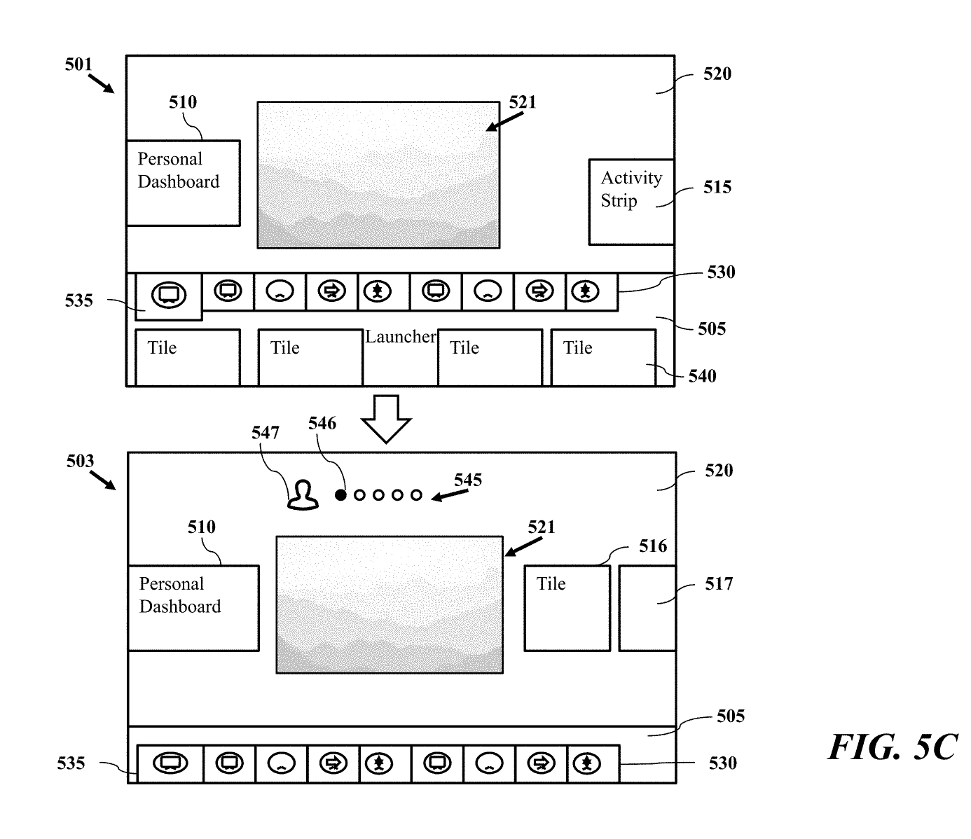

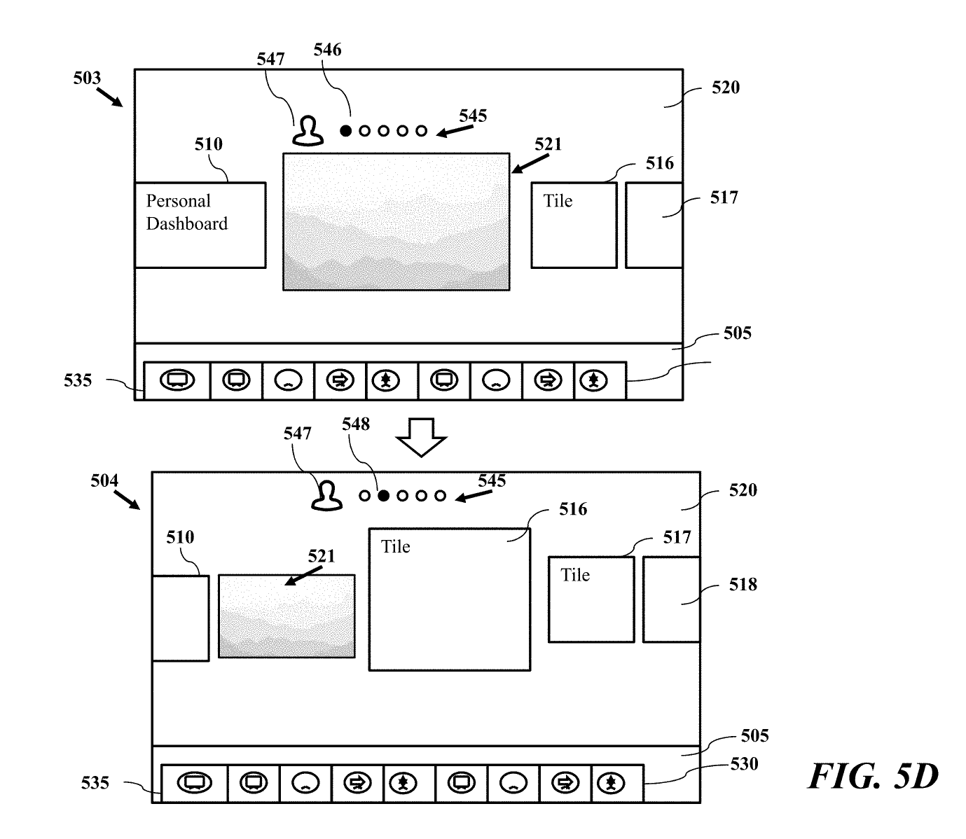

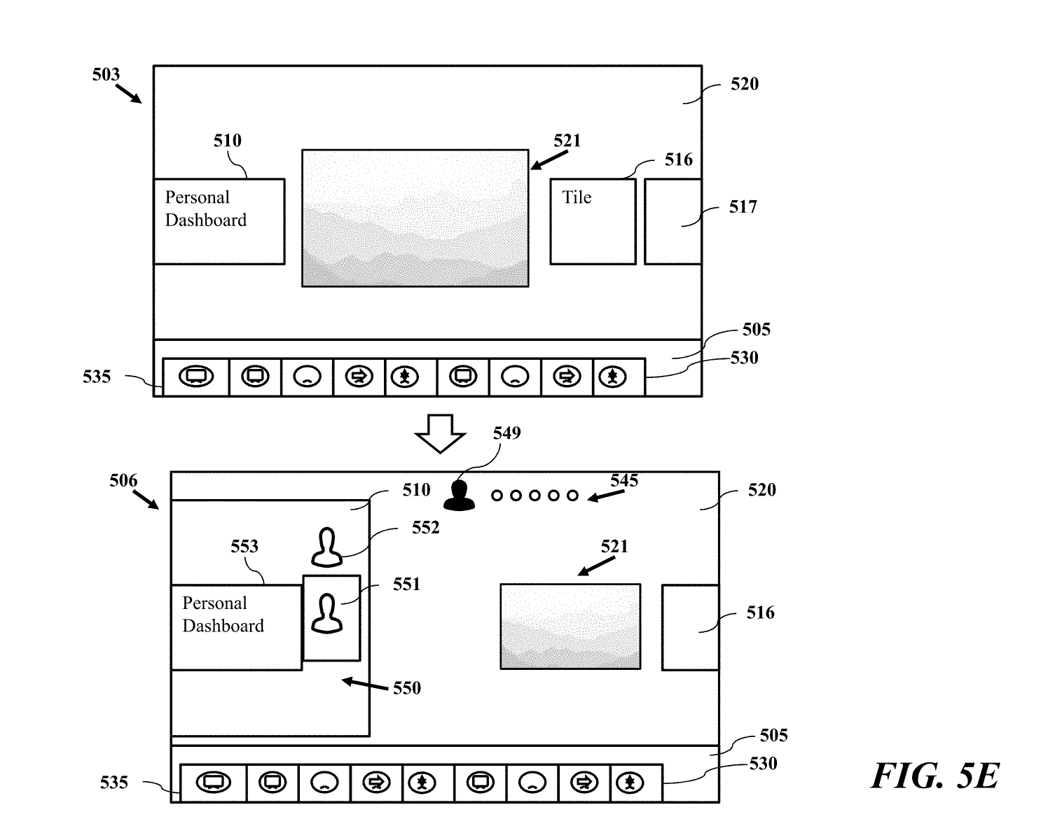

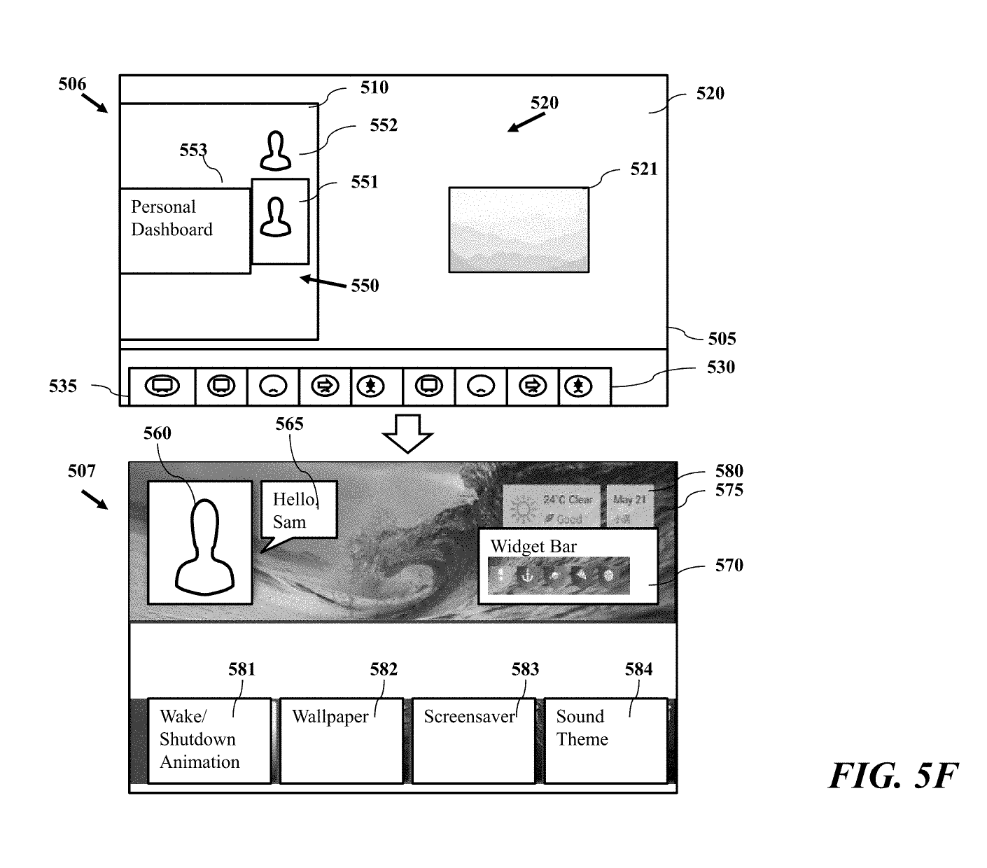

According to one embodiment, the control interface does not have a single presentation view, but rather, several levels of views. As such, the presentation size of each component and the amount of area that each component occupies may be modified and updated by the display device to provide a visual interface for control of the display device. Updating the presentation format allows for many different features to be accessed based on navigation with the spatial arrangement model. In one embodiment, presentation of the control interface at block 305 is in response to first command and includes presentation of a first format for the launcher component, a first format for the dashboard component and a first format for activity strip each, wherein a first format of components includes a display format of reduced size and functionality for each component. A first format for display of the control interface according to an exemplary embodiment is shown in FIG. 5A.

At block 315, the display device detects a command for navigation relative to the control interface. In one embodiment, for an initial presentation the control interface, a highlight element is included in a tab bar of the launcher component (e.g., the left most tab element of the launcher bar). According to another embodiment, the high light element is presented at a location associated with the displayed content. It should also be appreciated that the highlight component may be presented with the personal dashboard component of activity bar component of the control interface. The highlight may relate to increased sized of the graphical elements and/or a visual treatment (e.g., glow, accent shadow, etc.) to a selection position on the display. Based on directional commands received from a remote control, the highlight will be moved. According to another embodiment, by moving the highlight, the format of the control interface may be updated.

At block 320, the display device updates presentation of the control interface to present an intermediate display format for the control interface. According to one embodiment, the intermediate display format presents the launcher component, dashboard component and activity strip as all being accessible, relative to the highlight position, for selection during presentation of the intermediate display format. In one embodiment, updating at block 320 allows for the control interface to switch from navigation within the launcher component to another component of the control interface. In one embodiment, the intermediate display format presents the launcher component as a bottom bar of tab elements, the dashboard component as a graphical representation of a selected user dashboard, and the activity strip as a plurality of content tiles arranged in a horizontal strip with reduced size. Each of the launcher component, the dashboard component and the activity strip are configured for navigation by directional commands within the component and for expanded and reduced presentation formats based on navigation within a component.

Updating at block 320 can reflect a selection of content at block 315 and result in display device presenting the selected content. Alternatively, updating can change a visual level to provide multiple layers of control with each format. In some embodiments, updating allows for updating the position of a highlight element and the display format of the component. For example, updating can include expanding the display area of the launcher component to reveal content associated with a secondary display region.

According to one embodiment, updating the control interface presentation at block 320 can include launching content selected in the launcher component. For example when a broadcast program (e.g., TV program) is selected, the display device can tune to the broadcast program channel. For video content on-demand, gaming applications or applications in general, updating the control interface presentation at block 320 can include presentation of or launching of the content or application. In certain embodiments, updating the control interface presentation at block 320 can include updating selections of the personal dashboard and/or selection of a user profile for a personal dashboard.

FIG. 4 depicts a process for presentation of a control interface according to other embodiments. Process 400 represents a flow for presentation and navigation of a control interface and provides a visual representation associated with spatial arrangement model. According to one embodiment, process 400 is initiated with display of an initial presentation of control interface at block 405. As will be described in FIG. 5A, components of the control interface may transition into the display window to appears as sliding into the screen within the content displayed by the display device remaining presented behind the control interface components. According to one embodiment, presentation at block 405 is a home presentation of the control interface, which provides a starting point or base for presentation of the control interface. According to one embodiment, limited navigation of the launcher component can be provided to allow for selection or highlighting of one or more tab elements of the launcher bar. Based on each tab selected/highlighted, the elements included in the primary display region may be updated. These navigations and updates may be provided within the initial presentation format of the launcher component.

In response to one or more commands relative to the control interface, process 400 includes presentation of an intermediate format of the control interface at block 410. The intermediate presentation may adjust the presentation format of components already displayed. Relative to the initial presentation format, content of the display device (e.g., tuned program) may transition (e.g., appear to drop back) to a reduced size and appear within the activity bar component. Similarly, the launcher bar may drop down to become a lower bar. In addition the dashboard component may appear larger in size. Other components may also appear in the intermediate presentation format. As such, the visual presentation levels of each component is modified. From the intermediate format of the control interface a directional commands associated with the spatial arrangement model can thus launch or navigate a highlight element to a particular component of the control interface. By way of example, a left directional command may select/present control focus to the dashboard component. Similarly, a right direction command may select/present control focus to the activity bar component. In addition, a down direction command may select/present the launcher component. In certain embodiments, a down command may revert to the initial presentation format of the control interface. FIG. 4 illustrates that navigation to a launcher component, dashboard component and/or activity bar can return back to the intermediate control format.

At block 415, process 400 includes presentation of the launcher. At block 420 the process 400 includes presentation of the dashboard component. At block 425, the activity strip component is presented. Presentation at blocks 415, 420 and 425 allows for navigation and updating of the components based on detected commands. Based on the navigation the display device may be controlled to launch content, change settings and select one or more features of the display device.

FIG. 5A depicts a graphical representation of control interface components and a spatial arrangement model according to one or more embodiments. According to one embodiment, a spatial arrangement model 500 provides a layout or arrangement of control interface components. According to one embodiment, spatial arrangement model 500 is a shaped model having a launcher component 505 associated with the bottom terminus of the T, personal dashboard component 510 associated with the left terminus of the T, and activity strip component 515 associated with the right terminus of the T. In that fashion, the spatial arrangement model provides a roadmap to navigating to component features of the display device. According to another embodiment, spatial arrangement model may include additional terminal ends for optional components 516, 517, and 518.

Spatial arrangement model 500 is depicted relative to display 520 including content 521. Based on a command to present the control interface, components 505, 510 and 515, may transition as overlays to content 521 to present the initial display format of the control interface. A graphical representation of the initial presentation format is depicted as 501 in FIG. 5B. Based on one or more additional commands, the display format of components 505, 510 and 515 may be updated.

FIG. 5B-5F depicts graphical representations of control interface display formats according to one or more embodiments for components 505, 510 and 515 of FIG. 5A.

FIG. 5B depicts initial presentation format 501 including components 505, 510 and 515. Components 505, 510 and 515 are presented relative to display 520. As shown in FIG. 5B, content 521 is presented as a reduced size tile of still or video image of the last input to display 520. Display content 521 may be a screen shot of the content when a control interface command is received. Launcher component 505 includes tab bar 530 with highlight 535 on the leftmost tab. A primary display area 540 of launcher component includes a plurality of tiles each associated with content based on the tab with highlight 535.

According to one embodiment, from initial format 501 the display device presents display format 502. Intermediate format may be based on a down command. As such, the control interface still presents components 510 and 515 in addition to display content 521; however, the presentation format of launcher 505 is modified and increased in size. Display format 502 may represent an intermediate format of the control interface. In display format 502, launcher bar component additionally includes at least a portion of tiles, shown as 541, associated with a secondary display region of the launch component. Display format 502 may present the highlight with tile 542 having increased size.

FIG. 5C depicts initial presentation format 501 transitioning to intermediate format 503. According to one embodiment, from initial format 501 the display device presents display format 503 which may be based on an up command. As such, the control interface still presents components 505, 510 and 515 in addition to display content 521; however, the presentation format of launcher 505 is modified with reduced size. Display format 503 may represent an intermediate format of the control interface. In display format 503, personal dashboard component 510 may be presented with an increased size and content tiles 516 and 517 of the activity strip are shown. In format 503, the focus may be on display content 521. In that fashion a user can select display content 521 to return to the content. Alternatively, a left command will present dashboard component 510. A right component may select a content tile of the activity strip, such as tile 516. A down command may revert back to format 501 for operation within launcher component 505. Accordingly, from intermediate presentation 503, components 505, 510 and 515 may be selected and/or navigated to.

According to one embodiment, format 503 includes a status bar 545 indicated the position of the highlight with respect to the dashboard component and activity strip component. Symbol 547 represents position of the control interface with the dashboard component. Whereas symbol 546 can represent the tile of the activity strip. Accordingly the dashboard component can provide an indicated of the location of the control interface and in particular the activity strip relative to other components of the control interface. From display format, a down command may revert back to format 501. Similarly right commands may advance to tile 517 for selection of other tile elements.

FIG. 5D depicts format 503 transitioning to format 504. Format 504 relates to a presentation format in response to a right command. In format 504, the control interface still presents components 505, 510 and the activity strip in addition to display content 521. Display content 521 is shifted such that the highlight position is associated with tile 516 of activity strip, tile 516 presented with increased size. The activity strip also includes a portion of tile 518. In addition, status bar 545 is updated with symbol 548 to indicate position within the control interface.

According to one embodiment, the activity strip is presented as a horizontal deck of graphical elements that may be scrolled through to select content. According to one embodiment, content for the activity strip is selected based on the current content being displayed, content available and recommended content for a user profile. By way of example, if the display device is currently tuned to a particular genre or type of broadcast content, activity strip 515 and tile 516 may relate to broadcast program that is currently airing and/or on demand that a user may be interested in. Selection of the tile can launch the suggested program. Activity strip can also include non-related content or procured content based on a user profiles viewing habits.

FIG. 5E depicts format 503 transitioning to format 506. Format 506 relates to a presentation format in response to a left command. In format 506, the control interface still presents component 505, display content 521, and tile 516 of the activity strip. Display content 521 is shifted such that the highlight position is associated with dashboard 510. Status bar 545 is presented in format 506 with symbol 549 highlighted.

In format 506, dashboard component 510 is presented according to one embodiment including user selection 550 to select one or more user profiles associated with graphical elements 551 and 552 which may represent user profile avatars. Dashboard component 510 also includes a display element 553 representing a screenshot of a selected user profile such as the user profile indicated by element 551. According to one embodiment, directional commands (e.g., up, down, etc.) can be used to select a different user profile, which will in turn result in control interface presenting an updated element 553 as a screen shot for the selected user profile. A left command form format 506 will result in presentation of the dashboard component interface shown as format 507 in FIG. 5F.

FIG. 5F depicts format 506 transitioning to format 507. Format 507 relates to a presentation format in response to a left command from format 506. In format 507, a user interface is presented based on the dashboard component. The interface in format 507 includes a graphical element 560 associated with a user avatar, welcome message 565, widget bar 570, background 575 and notifications shown as 580. According to one embodiment the personal dashboard presents a series of tiles such as tile 581 associated with settings for wake/shutdown animations, wall paper 582, screensaver 583 and sound theme 584. Elements for format 507 all relate to a dashboard component of a display device for personalizing a user experience. Selection of tile elements 581-584 can launch a menu for input of personalization settings.

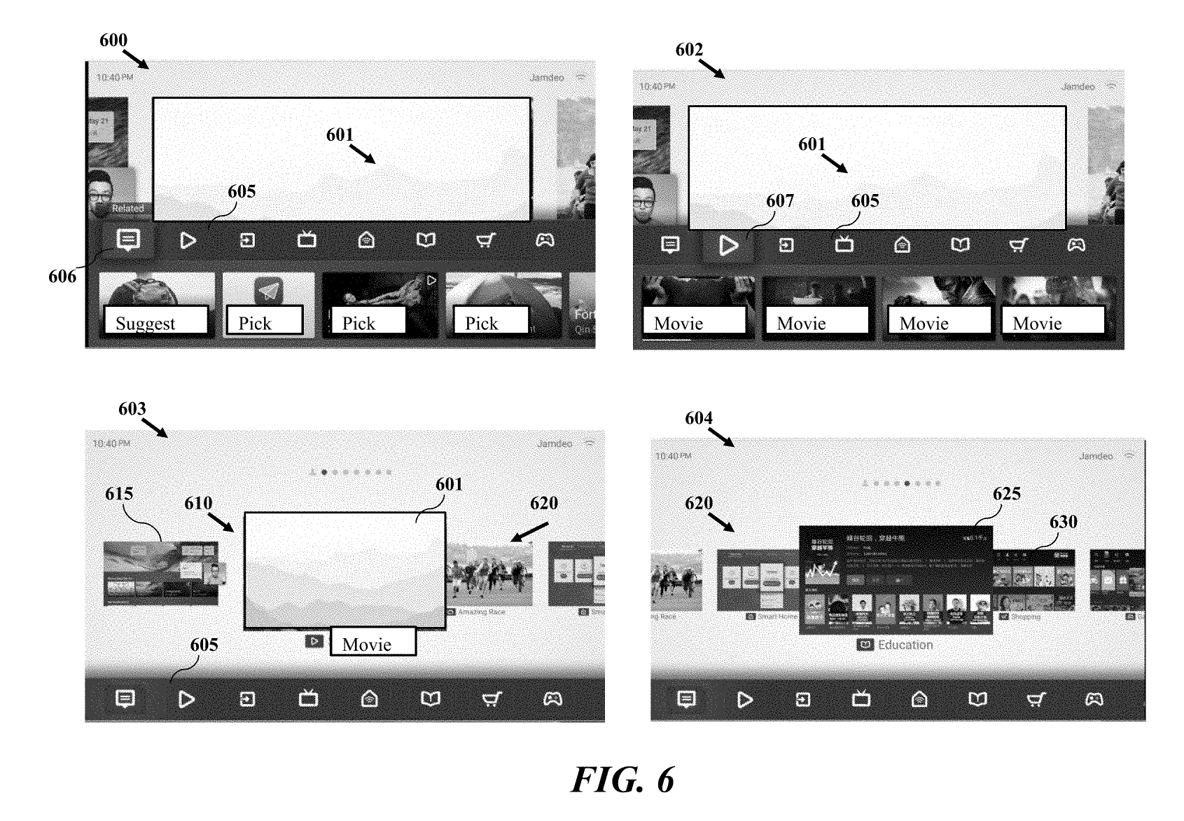

FIG. 6 depicts a graphical representation of control interface components and presentation according to one or more embodiments. FIG. 6 depicts an exemplary transition of direction commands within a spatial arrangement model. Display format 600 relates to an initial presentation of a control interface with display content 601 and launcher bar 605 of a launcher component including a highlight element on tab element 606 of launcher bar 605. According to one embodiment, tab element 606 of launcher bar 605 relates to a suggested tab such that elements of the launcher component are presented as recommendations based on the current display content 601 and/or one or more recommendations for a user. Recommendations within the launcher component may be curated by the display device or pushed to the display deice for inclusion in the launcher component. From display format 600, the display device can present format 602 including tab element 607, relating to a video on demand tab element, of launcher bar highlighted. Tab element 607 is directed to a source of content different from tab element 606, and as such the launcher component will include different elements for primary and secondary display areas. Thus, updating the display presentation of the control interface can apply to navigation commands relative to the launcher bar and tab elements.

Display format 603 depicts launcher bar 605 reduced to a bottom bar, a tile element 610 for display content 601, dashboard screenshot 615 and activity strip 620. Format 604 depicts the transition from format 603 based on a right directional commands where the activity strip presents highlight on element 620 and allows for further selection of elements within the activity bar, such as element 630.

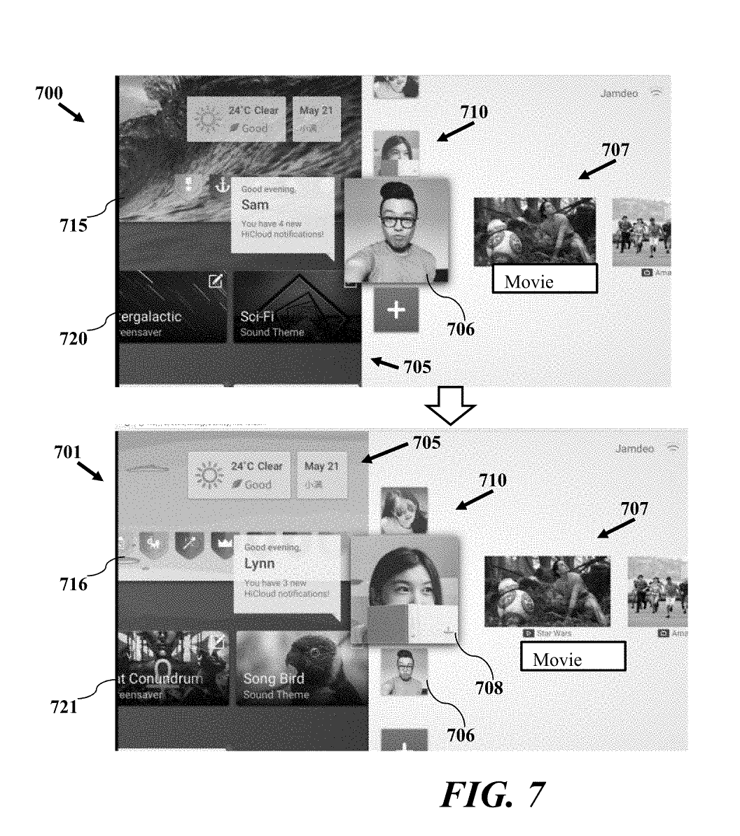

FIG. 7 depicts a graphical representation of a dashboard component according to one or more embodiments. According to one embodiment, FIG. 7 depicts the selection of a user profile from a presentation of a dashboard component. Display format 700 depicts dashboard component 705 and with user avatar image 706 highlighted in user selection strip 710. Format 700 also includes activity strip 707. Based on selected user avatar image 706, a screenshot of a personal dashboard is presented included background image 715 and tile element 720 associated with the selected user profile. From presentation format 700 a user/operator may select other user profiles based on a directional command.

Display format 701 relates to selection of user profile 708. As a result, the control interface of a display device is updated to present personal dashboard component 705 including updated wallpaper 716 and tile element 721 associated with selected user 708. According to one embodiment, presentation of display format 701 may relate to updating presentation of a control interface.

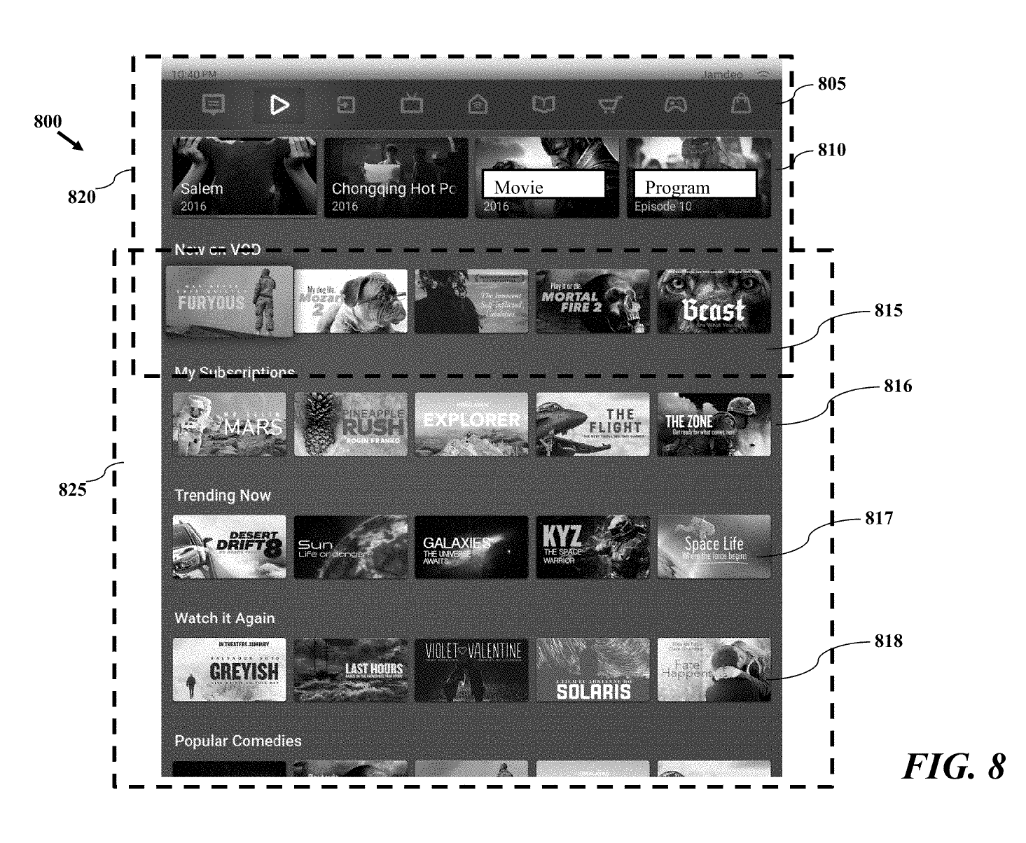

FIG. 8 depicts a graphical representation of a launcher component according to one or more embodiments. According to one embodiment, each component of the control interface is displayed in portions, or windows, wherein the display window of each component may provide a scrollable interface. Launcher component 800 presents graphical representation of elements which may be included on a display screen. Launcher component 800 includes tab bar 805, primary display bar 810 including a series of tiles each representing content that is recommended based on a selected tab element of tab bar 805. Tab bar 805 may provide access to all the key applications and inputs of the display device. In one embodiment tab bar provides, elements for live TV, video on demand, inputs, applications, educations/learning sites, gaming, shopping and Elements of tab bar 805 may be added and reordered in addition to the default fixed items. Primary display bar 810 may relate to primary contextual tiles that are highly contextual and present options specific to the application or section of tab bar 805. Primary display bar 810 may provide key action shortcuts to provide a utility that allows users to resume an activity or directly access a section of an application.

Launcher component 800 may also include a secondary display a series of secondary bars also including recommendations shown as display bars 815, 816, 817 and 818. According to one embodiment, the primary or initial display region of the launcher may include area 820. However, navigation within the launcher component may present elements of a secondary display area 825. In one embodiment, when presenting bars of the secondary display area 825, the launcher component may still present the tab bar 805.

Display bars 815, 816, 817 and 818 may provide recommendations or content, titles, applications or other elements that may be presented by the display device. According to one embodiment, display bars 815, 816, 817 and 818 are categorized recommendations that reflect the interests and activities of the user.

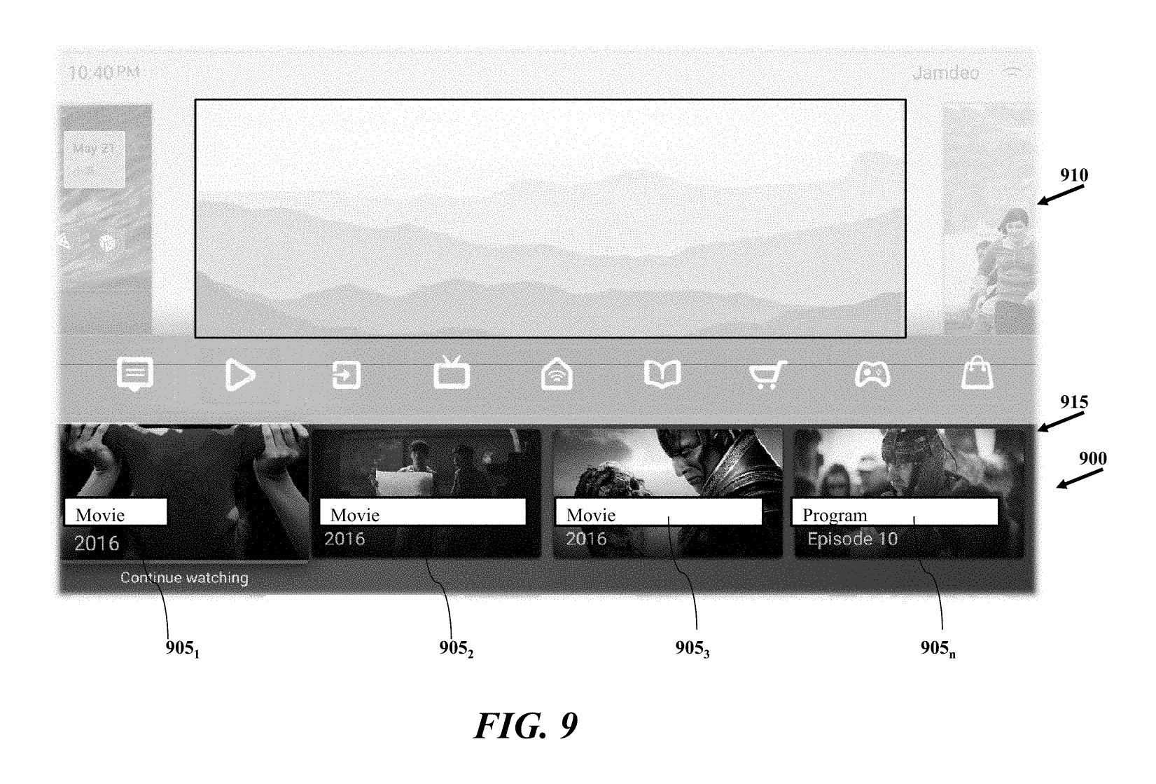

FIG. 9 depicts a graphical representation of a launcher component according to one or more embodiments. According to one embodiment, a launcher component is presented with a launcher format 900 including a bar of key action shortcuts. Launcher format 900 is presented over display content 910 including launcher bar 915 having tiles 905₁₋ₙ. Launcher format 900 includes tiles 905₁₋ₙ to provide the highest priority recommendations. Launcher tiles 905₁₋ₙ are selected by the display device to provide highly contextual options specific to the application or selection of a launcher component. Launcher tiles 905₁₋ₙ can include key action shortcuts to provide utilities that allow users to resume an activity or directly access a section of an App from the Launcher. In one embodiment, key action tiles can include useful shortcuts back to content that the user has interacted with and the strongest content recommendations from the application selected in a launcher bar.

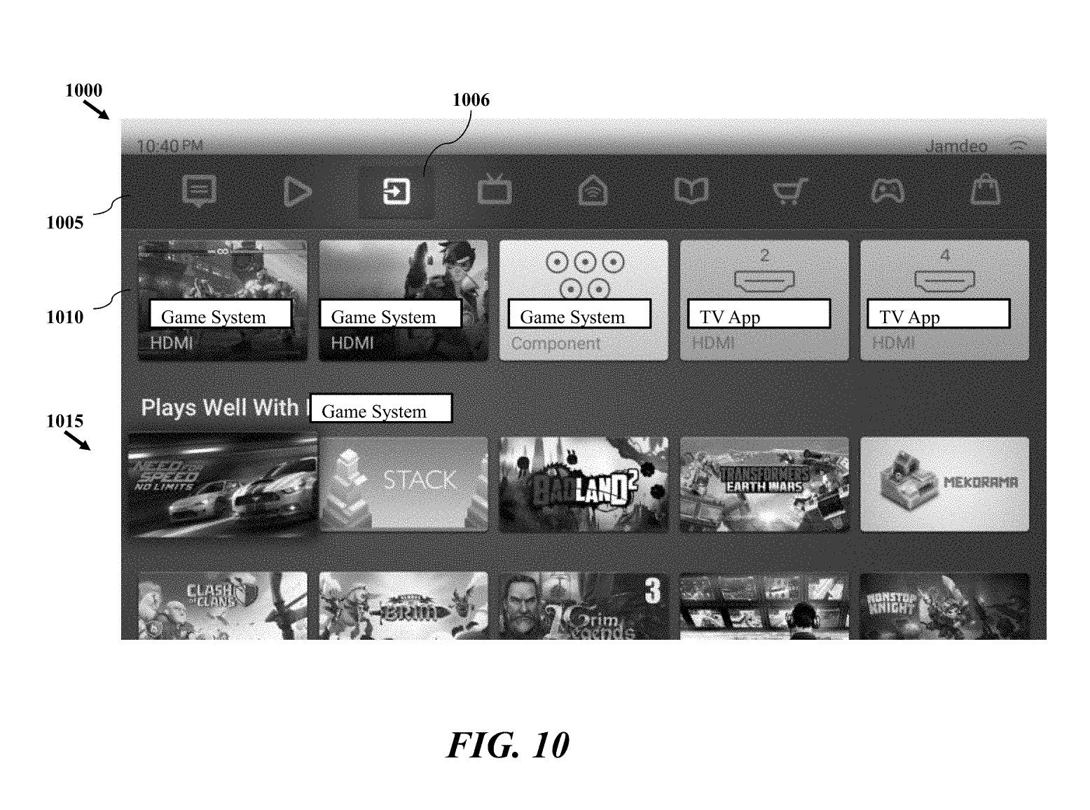

FIG. 10 depicts a graphical representation of a launcher component according to one or more embodiments. The launcher component can presented primary and secondary bars based on the type of tab elements selected. Launcher format 1000 includes launcher bar 1005, primary regions 1010 and secondary region 1015. Based on selection of tab 1006 for inputs of a display device, of launcher bar 1005, the control interface presents bar 1010 including selected the Inputs icon launches the last used input (e.g., gaming system).

Key action tiles included in bar 1010 can include content recommendations derived from the last used input. For a gaming system input, bar 1010 can include recent games that the user has played or installed. Bars of secondary region 1015 can include recommendations for the gaming system input that can be selected by the display device including content recommendations from a game center application and/or games installed on the display device.

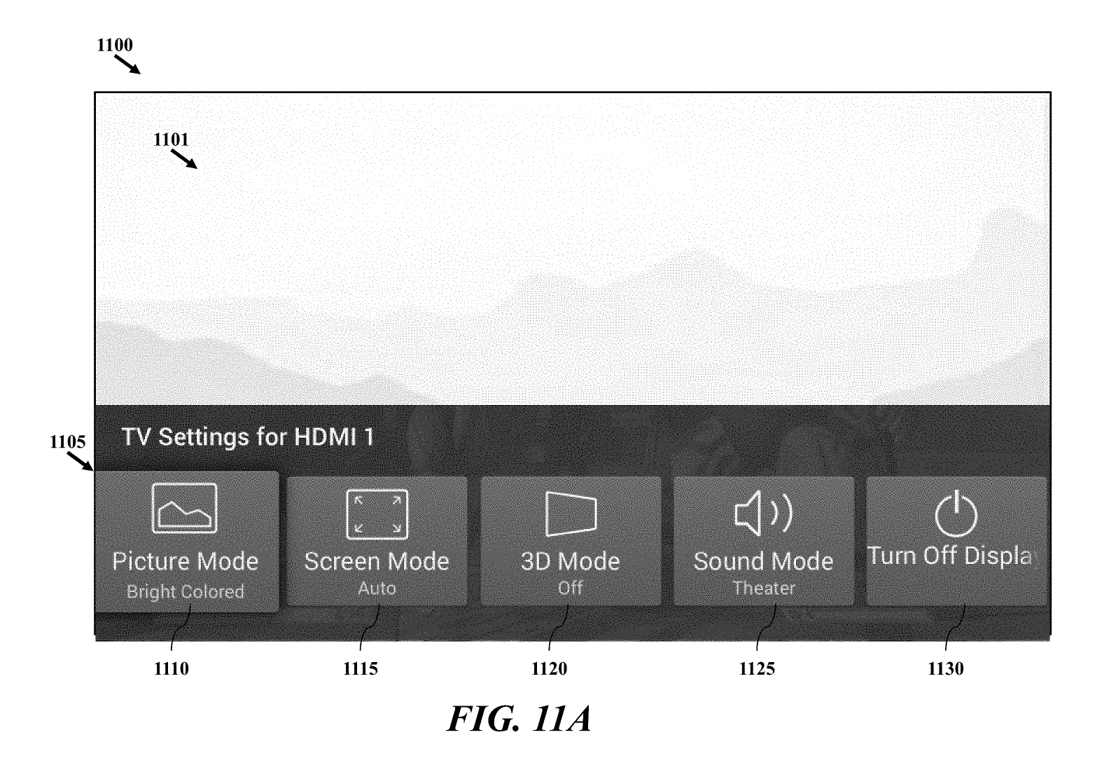

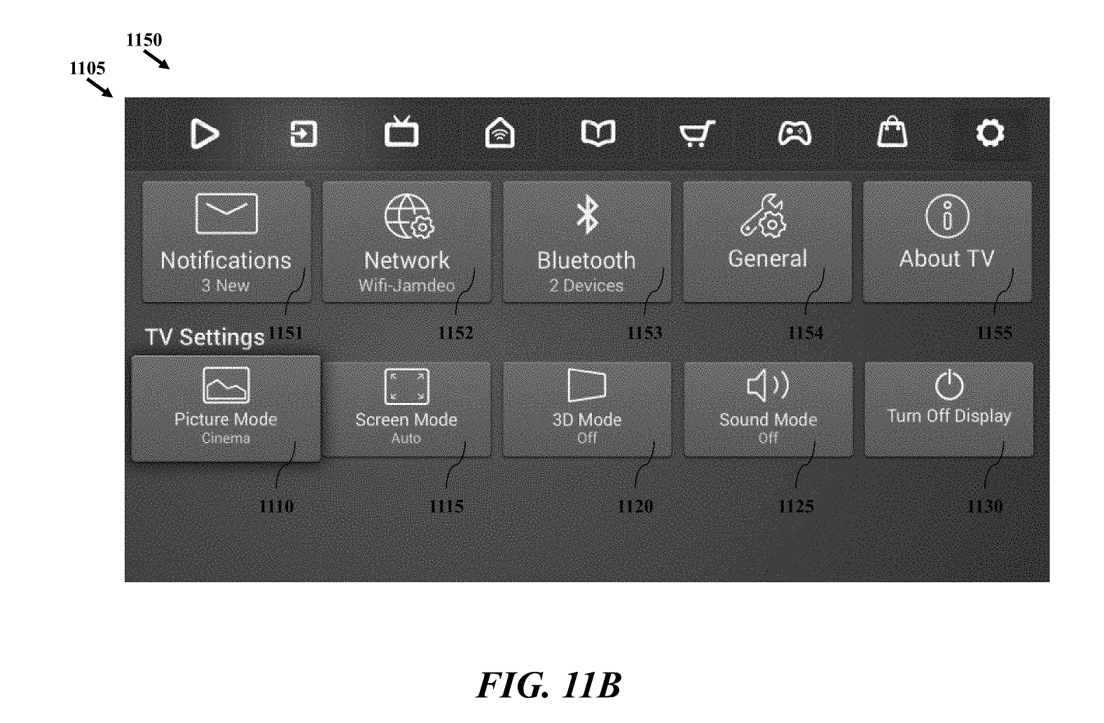

FIGS. 11A-11B depict graphical representations of a launcher component according to one or more embodiments. In FIG. 11A, presentation format of control interface 1100 includes display content 1101 and launcher bar 1105. Launcher bar 1105 includes selectable elements for control features including picture mode 1110, picture mode 1115, picture mode 1120, picture mode 1125, and display power 1130. In FIG. 11B, expanded launcher control 1150 is presented including launcher bar 1105, based on a down directional command from control interface 1000 of FIG. 11A. Launcher control 1150 includes additional control features including notifications tile 1151, network settings tile 1152, Bluetooth connections 1153, general settings 1154, and display device information 1155. According to one embodiment, launcher control 1150 provides an expansion of the launcher bar for display device settings.

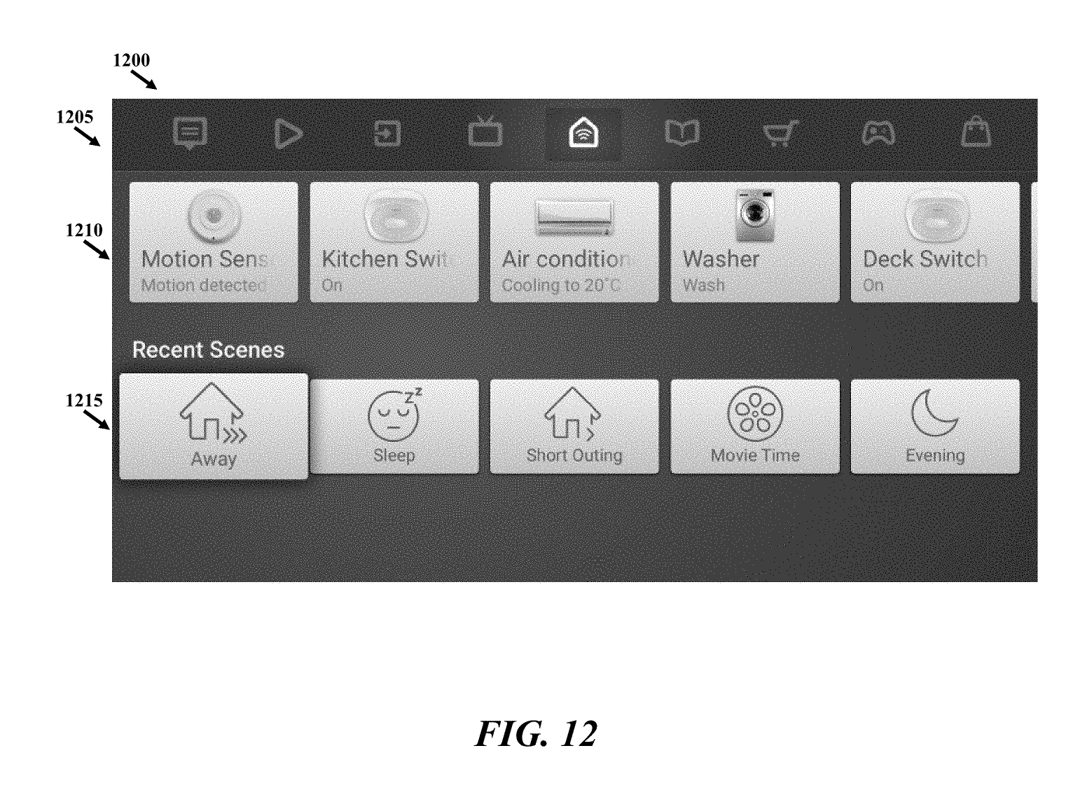

FIG. 12 depicts a graphical representation of a launcher component according to one or more embodiments. Control interface 1220 relates to a possible configuration that may be updated by the display device in response to commands received by a user device relative to a control interface. Presentation format of control interface 1200 includes launcher bar 1205 and key elements bar 1210. In one embodiment, key elements bar 1210 is presented in response to selection of a smart home icon from launcher bar 1205. Key elements bar 1210 can provide recent smart home device tiles and their respective statuses. Key elements bar 1210 can include selectable elements for smart device notifications and recent scenes bar 1215 including graphical elements for interaction with one or more applications linked to the display device.

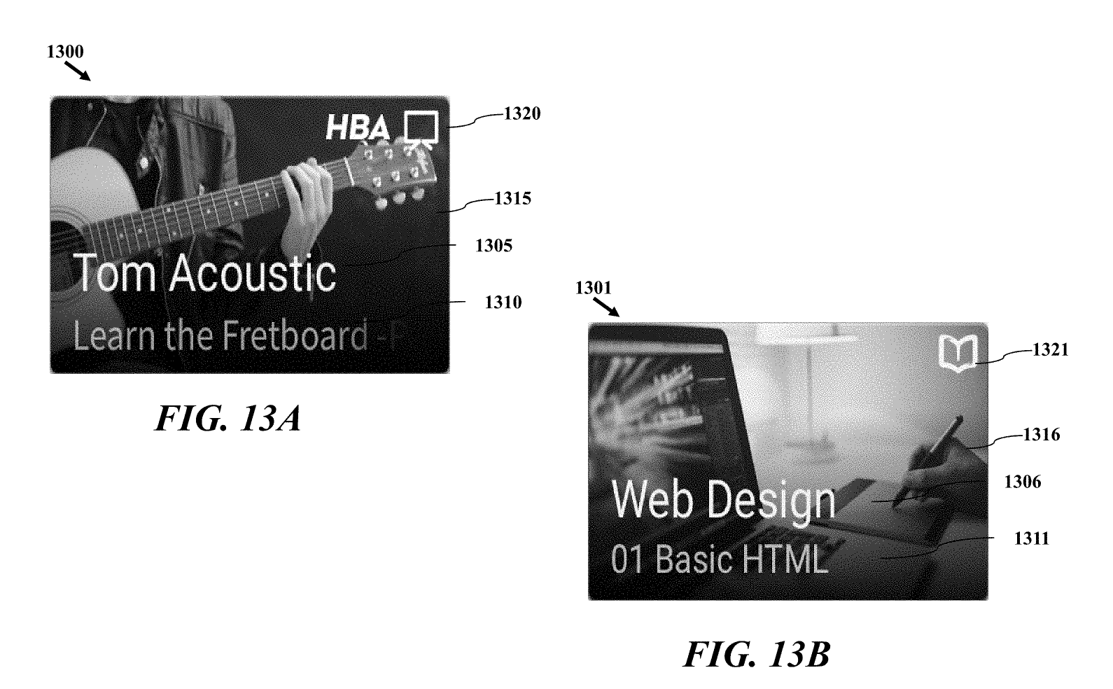

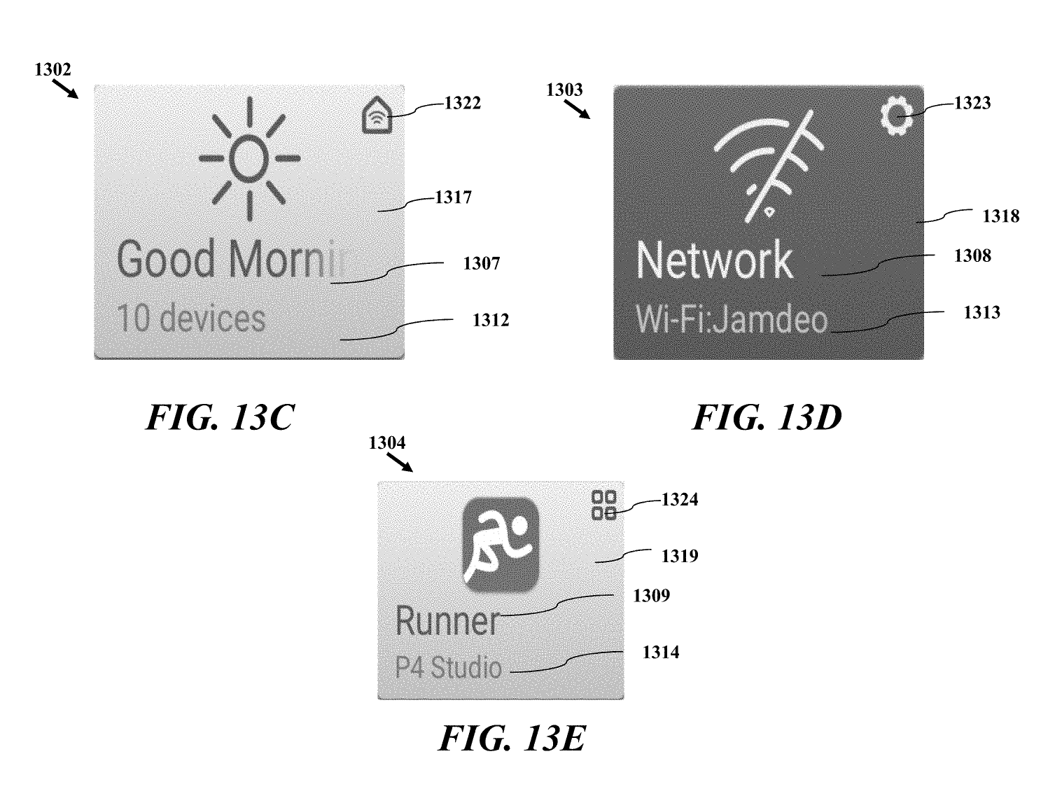

FIGS. 13A-13E depict graphical representations of launcher components according to one or more embodiments. According to one embodiment, a control interface presents elements with a tile configuration. To improve the controllability of the control interface, tile elements of the interface may be configured with particular design formatting. According to one embodiment, the control interface may create tile elements and representations based on screenshots of functional elements and/or data associated with each element. Tiles depicted in FIGS. 13A-13E depict exemplary representations of elements within the control interface. According to one embodiment, tiles referenced above relating to a launcher component such as a primary display area and secondary display area may relate to one or more tile elements of FIGS. 13A-13E. In additional, tile elements discussed above with respect to an activity strip may be formatted as one or more of tile elements of FIGS. 13A-13E.

FIG. 13A depicts a television broadcast tile element 1300 including program name 1305, program related description/info 1310, program image 1315 (e.g., screenshot, image, etc.) and content source icon (Live TV) 1320. Tile elements may be formatted based on a tab element of a launcher bar. Broadcast tile element 1300 can include a progress indicator for content being displayed by the display device that is also represented by a tile element in a launcher display. (e.g., only in “continue watching” state).

FIG. 13B depicts educational tile element 1301 including learning program name 1306, program related description/info 1311, program image 1316 (e.g., screenshot, image, etc.) and content source icon 1321. FIG. 13C depicts a smart home notification tile element 1302 including welcome message 1307, number of devices with notifications 1312, image 1317(e.g., notification icon, etc.) and tab element icon 1322. FIG. 13D depicts a network tile element 1303 including input source name 1308, network name 1313, input image 1318 and content source icon 1323. FIG. 13E depicts an application tile element 1304 including application name 1309, application subtitle name 1314, application image 1319 and application icon 1324.

While this disclosure has been particularly shown and described with references to exemplary embodiments thereof, it will be understood by those skilled in the art that various changes in form and details may be made therein without departing from the scope of the claimed embodiments.

What is claimed is:

1. A method for display device operation including presentation of a control interface, the method comprising:
detecting, by a display device, a first command for presentation of a control interface for the display device;
presenting, by the display device, a control interface according to a spatial arrangement model and including interface components, wherein the control interface is presented to include
a graphical presentation of a launcher component, the launcher component configured for selection and presentation of content,
a graphical presentation of a dashboard component, the dashboard component configured to present a personalized interface based on a user profile, and
a graphical presentation of an activity strip, the activity strip configured to present a plurality of tile elements for selected content;
detecting, by the display device, a command for navigation relative to the control interface; and
updating, by the display device, presentation of the control interface to present an intermediate display format for the control interface, wherein each of the launcher component, dashboard component and activity strip are accessible for selection during presentation of the intermediate display format.

2. The method of claim 1, wherein the first command is received by the display device from a remote control device.

3. The method of claim 1, wherein the spatial arrangement model defines the arrangement of each of the launcher component, dashboard component and activity strip relative to one another and provides a plurality of display presentation formats for each of the launcher component, dashboard component and activity strip to provide navigation within each component and control of the display device.

4. The method of claim 1, wherein the spatial arrangement model is characterized by a T shape layout which each of the launcher component, dashboard component and activity strip relative positioned at a terminus of the T shape.

5. The method of claim 1, wherein the launcher component includes a tab bar having a plurality of tab elements, a primary region and a secondary region, wherein the primary region and secondary region are presented to include a plurality of content tiles based on a selected tab of the tab bar.

6. The method of claim 1, wherein personal dashboard component includes a control interface within at least one of a background, avatar, welcome message, widget and content strip based on a selected user profile.

7. The method of claim 1, wherein the activity strip includes a plurality of graphical display tiles, wherein each tile is arranged in a horizontal strip to provide selected content based on activity detected with the display device.

8. The method of claim 1, wherein control interface presentation in response to first command includes presentation of a first format for the launcher component, a first format for the dashboard component and a first format for activity strip each, wherein a first format of components includes a display format of reduced size and functionality for each component.

9. The method of claim 1, wherein the intermediate display format presents the launcher component as a bottom bar of tab elements, the dashboard component as a graphical representation of a selected user dashboard, and the activity strip as a plurality of content tiles arranged in a horizontal strip with reduced size.

10. The method of claim 1, wherein each of the launcher component, the dashboard component and the activity strip are configured for navigation by directional commands within the component and for expanded and reduced presentation formats based on navigation within a component.

11. A digital television comprising:
a display configured to present a control interface; and
a processor coupled to the display, the processor configured to
detect a first command for presentation of a control interface for the display device;
present a control interface according to a spatial arrangement model and including interface components, wherein the control interface is presented to include
a graphical presentation of a launcher component, the launcher component configured for selection and presentation of content,
a graphical presentation of a dashboard component, the dashboard component configured to present a personalized interface based on a user profile, and
a graphical presentation of an activity strip, the activity strip configured to present a plurality of tile elements for selected content;
detect a command for navigation relative to the control interface; and
update presentation of the control interface to present an intermediate display format for the control interface, wherein each of the launcher component, dashboard component and activity strip are accessible for selection during presentation of the intermediate display format.

12. The device of claim 11, wherein the first command is received by the display device from a remote control device.

13. The device of claim 11, wherein the spatial arrangement model defines the arrangement of each of the launcher component, dashboard component and activity strip relative to one another and provides a plurality of display presentation formats for each of the launcher component, dashboard component and activity strip to provide navigation within each component and control of the display device.

14. The device of claim 11, wherein the spatial arrangement model is characterized by a T shape layout which each of the launcher component, dashboard component and activity strip relative positioned at a terminus of the T shape.

15. The device of claim 11, wherein the launcher component includes a tab bar having a plurality of tab elements, a primary region and a secondary region, wherein the primary region and secondary region are presented to include a plurality of content tiles based on a selected tab of the tab bar.

16. The device of claim 11, wherein personal dashboard component includes a control interface within at least one of a background, avatar, welcome message, widget and content strip based on a selected user profile.

17. The device of claim 11, wherein the activity strip includes a plurality of graphical display tiles, wherein each tile is arranged in a horizontal strip to provide selected content based on activity detected with the display device.

18. The device of claim 11, wherein control interface presentation in response to first command includes presentation of a first format for the launcher component, a first format for the dashboard component and a first format for activity strip each, wherein a first format of components includes a display format of reduced size and functionality for each component.

19. The device of claim 11, wherein the intermediate display format presents the launcher component as a bottom bar of tab elements, the dashboard component as a graphical representation of a selected user dashboard, and the activity strip as a plurality of content tiles arranged in a horizontal strip with reduced size.

20. The device of claim 11, wherein each of the launcher component, the dashboard component and the activity strip are configured for navigation by directional commands within the component and for expanded and reduced presentation formats based on navigation within a component.
